(19) United States
(12) Patent Application Publication
(10) Pub. No.: US 2026/0322414 A1
(43) Pub. Date: Oct. 15, 2026

(54) METHOD FOR SEGMENTING RADIO-FREQUENCY FRONT-END ANTI-INTERFERENCE FILTERING, ELECTRONIC DEVICE, AND RADIO-FREQUENCY FRONT-END MODULE

(71) Applicant: NO.26 RESEARCH INSTITUTE OF CHINA ELECTRONICS TECHNOLOGY GROUP CORPORATION, Chongqing (CN)

(72) Inventors: Huaiqiang YU, Chongqing (CN); Bin CHENG, Chongqing (CN); Like DENG, Chongqing (CN); Xi WANG, Chongqing (CN); Shiping MAO, Chongqing (CN); Jinyi MA, Chongqing (CN); Lei ZHANG, Chongqing (CN); Yuting TAN, Chongqing (CN); Yi ZHAO, Chongqing (CN); Mingyan JIANG, Chongqing (CN)

(73) Assignee: NO.26 RESEARCH INSTITUTE OF CHINA ELECTRONICS TECHNOLOGY GROUP CORPORATION, Chongqing (CN)

(21) Appl. No.: 19/467,862

(22) Filed: Feb. 3, 2026

Related U.S. Application Data
(63) Continuation of application No. PCT/CN2024/109533, filed on Aug. 2, 2024.

(30) Foreign Application Priority Data
Aug. 4, 2023 (CN) 202310978739.9

(51) Int. Cl. H04B 1/04; H04B 1/10

(52) U.S. Cl. CPC H04B 1/0475; H04B 1/10

(57) ABSTRACT

A method for segmenting RF front-end anti-interference filtering is disclosed. Based on the principle of minimizing the number of RF filters or maximizing the anti-interference capability, the working bandwidth, number, and center frequency of RF filters required for a switch-filter circuit are determined according to the RF working band, so that the working bandwidth of the switch-filter circuit formed by all RF filters at least cover each channel of the RF front-end; when there is an overlapped region in the working bandwidths of two RF filters with adjacent bandwidths in the switch-filter circuit, for the RF working frequency point in the overlapping region, one of the two RF filters corresponding to the overlapping region is selected according to different filtering requirements to perform anti-interference filtering processing on the RF working frequency point.

### CROSS REFERENCE TO RELATED APPLICATION

The present disclosure is a continuation application of International Patent Application No. PCT/CN2024/109533, filed on Aug. 2, 2024, and claiming the priority to Chinese Application No. 202310978739.9 filed on Aug. 4, 2023, the contents of all of which are incorporated herein by reference in their entirety for all purposes.

### TECHNICAL FIELD

The present application relates to the field of radio-frequency (RF) filtering technology, and in particular to a method for segmenting RF front-end anti-interference filtering, an electronic device, and a RF front-end module.

### BACKGROUND

At present, electromagnetic spectrum resources are becoming more and more crowded, and the electromagnetic environment is becoming more and more complex, resulting in higher and higher requirements for the anti-interference of the RF front-end in existing broadband electronic systems such as large-capacity communications and imaging radars. Radio frequency filters are RF electronic devices that attenuate or filter interference signals. Using multiple RF filters to form a switch-filter circuit to achieve broadband RF front-end anti-interference filtering has become an important technical means to enhance the anti-interference ability of broadband electronic systems. The switch-filter circuit performs switching and gating between multiple RF filters through single-pole multi-throw (SPMT) switches and performs anti-interference filtering on channels of the RF front-end within different signal bandwidth ranges based on RF filters with different filtering bandwidths, thereby performing broadband anti-interference filtering on the RF front-end.

### SUMMARY

The present application provides a method for segmenting RF front-end anti-interference filtering, which includes:
obtaining the RF working bands to-be-covered of the RF front-end, and determining the working bandwidth, number, and center frequency of the required RF filters according to the RF working bands based on a principle of minimizing the number of RF filters or maximizing the anti-interference capability, so that the working bandwidth of the switch-filter circuit formed by all RF filters at least covers each channel of the RF front-end; and
when the working bandwidths of two adjacent RF filters in the switch-filter circuit have an overlapping region, the RF working frequency points within this overlapping region can be processed by either of the two RF filters for anti-interference filtering. The specific selection of the RF filter corresponding to the working frequency point in the overlapping region is determined by the parameter priority of the RF front-end.

An electronic device includes:
one or more processors; and
a storage device used to store one or more programs, when one or more programs are executed by one or more processors, the electronic device implements any of the above-mentioned methods for segmenting RF front-end anti-interference filtering.

An RF front-end module includes a switch-filter circuit manufactured under the guidance of any of the above-mentioned methods for segmenting RF front-end anti-interference filtering.

### BRIEF DESCRIPTION OF DRAWINGS

FIG. 1 is a schematic diagram showing steps of a method for segmenting the RF front-end anti-interference filtering in the present application.

FIGS. 2 to 5 are schematic diagrams showing the arrangement and overlap of various RF filters in a RF working band to be covered in one or more embodiments of the present application.

FIG. 6 shows a curve of insertion loss as a function of frequency and a curve of group delay as a function of frequency for an acoustic filter with a center frequency of 965 MHz used in one or more embodiments of the present application.

FIG. 7 is a schematic diagram showing the structure of a computer system 700 corresponding to an electronic device shown in one or more embodiments of the present application.

FIG. 8 is a flow chart showing a step of determining the working bandwidth, number, and center frequency of the required RF filter according to the RF working band based on the principle of minimizing the number of RF filters.

FIG. 9 is a flow chart showing a step of determining the working bandwidth, number, and center frequency of the required RF filter according to the RF working band based on the principle of maximizing the anti-interference capability.

FIG. 10 is a flow chart showing a step of determining the working bandwidth, number, and center frequency of the required RF filter according to the RF working band.

FIG. 11 is a flow chart showing a step of selecting one of two RF filters corresponding to an overlapping region according to a priority level for a parameter of the RF front-end to perform anti-interference filtering on a RF working frequency point.

FIGS. 12-14 are flow charts showing a step of determining a boundary working frequency point of the overlapping region according to the priority level for the parameter of the RF front-end.

### DESCRIPTION OF EMBODIMENTS

As described in the background, the inventors have found that the currently designed switch-filter circuits for broadband anti-interference filtering still have many defects. Generally, the switch-filter circuits are designed to cover RF working bands with higher frequencies and are based on pre-fabricated RF filters. The designed switch-filter circuits are universal, with fixed structure and fixed filtering performance. They can be used in many scenarios where the filtering performance requirements are not high, but are no longer applicable to certain occasions where the filtering performance requirements are relatively high. At the same time, limited by the structural performance of the RF filter, the designed switch-filter circuit cannot perform anti-interference filtering on certain RF working bands, and the designed switch-filter circuit cannot reversely guide the design of the RF filters.

The present application proposes a technical solution for segmenting RF front-end anti-interference filtering: first, based on the principle of minimizing the number of RF filters or maximizing the anti-interference capability, the working bandwidth, number, and center frequency of the RF filters required for the switch-filter circuit are determined according to the RF working band, and then the required operating parameters of the RF filters are flexibly designed according to the RF working band to be covered, so as to achieve tailor-made optimal filtering performance and guide the design of the RF filter in reverse; second, when there is an overlapping region in working bandwidths of two RF filters with adjacent bandwidths in switch-filter circuit, for the RF working frequency point in the overlapping region, selecting one of the two RF filters to perform anti-interference filtering on the RF working frequency point according to the different filtering requirements of the RF front-end. so as to achieve high-precision filtering while effectively balancing other performance requirements of the RF front-end or the electronic system, and further achieve directional and precise filtering.

The following describes the embodiments of the present application through specific examples, and those skilled in the art can easily understand other advantages and effects of the present application from the contents disclosed in this specification. The present application can also be implemented or applied through other different specific embodiments, and the details in this specification can also be modified or changed in various ways based on different viewpoints and applications without departing from the present application.

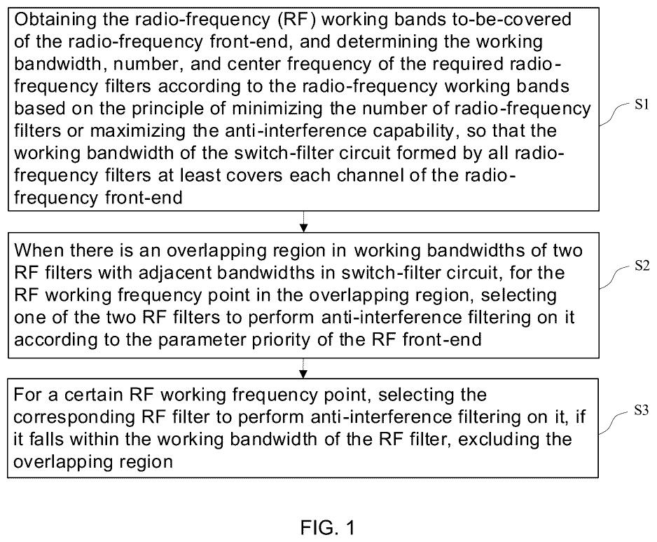

Please refer to FIGS. 1 to 14. It should be noted that the diagrams provided in this embodiment only illustrate the basic concept of the present application in a schematic manner, so the diagrams only show the components related to the present application but are not drawn according to the number, shape, and size of the components in actual implementation. The type, quantity, and scale of each component in actual implementation can be changed at will, and the layout and type of a component may also be more complicated. The structure, scale, size, etc. shown in the drawings attached to this specification are only used to match the content disclosed in the specification for people familiar with this technology to understand and read and are not used to limit the limiting conditions that the present application can be implemented, so they have no technical substantive significance. Any modification of the structure, change of the proportional relationship, or adjustment of the size should still fall within the scope of the technical content disclosed by the present application without affecting the effect that the present application can produce and the purpose that can be achieved.

As shown in FIG. 1, the present application provides a method for segmenting RF front-end anti-interference filtering, which includes:
Step S1: obtaining the RF working bands to-be-covered of the RF front-end, and determining the working bandwidth, number, and center frequency of the required RF filters according to the RF working bands based on the principle of minimizing the number of RF filters or maximizing the anti-interference capability, so that the working bandwidth of the switch-filter circuit formed by all RF filters at least covers each channel of the RF front-end;
Step S2: when there is an overlapping region in working bandwidths of two RF filters with adjacent bandwidths in switch-filter circuit, for the RF working frequency point in the overlapping region, selecting one of the two RF filters to perform anti-interference filtering on the RF working frequency point according to the parameter priority of the RF front-end; and
Step S3: for a certain RF working frequency point, selecting the corresponding RF filter to perform anti-interference filtering on the certain RF working frequency point, if it falls within the working bandwidth of the RF filter, excluding the overlapping region.

In one or more embodiments, in step S1, the RF working band to be covered at the RF front-end can be obtained through actual measurement or external acquisition input. The RF working band includes multiple different working frequency ranges, which can be a continuous RF working band or discontinuous discrete RF working bands. The RF working band to be covered at least covers each channel of the RF front-end, and the design can be done according to actual conditions, which is not limited here.

It should be noted that there are two methods to determine the working bandwidth, number, and center frequency of the RF filters required to cover the RF working band, namely, a method based on the principle of minimizing the number of RF filters and a method based on the principle of maximizing anti-interference capability. The working bandwidth, number, and center frequency of the RF filters required to cover the RF working band can be determined by using either or both of the two methods.

In one or more embodiments, in step S1, as shown in FIG. 8, determining the working bandwidth, number, and center frequency of the required RF filter according to the RF working band further includes:
Step S11: based on the principle of minimizing number of RF filters, designing the working bandwidth of each RF filter to be a maximum working bandwidth;
Step S12: obtaining a starting frequency and an ending frequency of RF working band, and sequentially arranging the RF filters, so that working bandwidths of the respective RF filters cover each channel of the RF front-end and just continuously and completely cover the RF working band from the starting frequency to the ending frequency, and working bandwidths of two adjacent RF filters have an overlapping region, wherein the bandwidth of the overlapping region is equal to the sum of the intermediate frequency (IF) signal bandwidth of the RF front-end and the frequency drift value (FDV) of the RF filter over a full temperature range; and
Step S13: according to the arrangement and overlap of each RF filter, calculating the number of the RF filters required to continuously and completely cover RF working band from the starting frequency to the ending frequency, and calculating the center frequency of each RF filter.

In one or more embodiments, in step S11, based on the principle of minimizing the number of RF filters, the working bandwidth (BW) of each RF filter is designed to be the maximum working bandwidth, which is the maximum bandwidth that the RF filter itself can achieve. This allows that each RF filter can perform anti-interference filtering on as many channels with different RF working frequencies in the RF front-end as possible, and the working bandwidth (BW) of each RF filter is determined, and the working bandwidths (BW) of each RF filter can be the same or different. The maximum working bandwidth of the RF filter is greater than or equal to the sum of the intermediate frequency (IF) signal bandwidth (called SBW) of the RF front-end, the frequency interval value (called FIV) between two adjacent channels, and the frequency drift value (FDV) of the RF filter over the full temperature range.

In one or more embodiments, the working bandwidth (BW) of the RF filter can be designed according to actual requirements, such as 3 dB bandwidth or 1 dB bandwidth; when there are multiple intermediate frequency (IF) signal bandwidths in the RF front-end, the intermediate frequency signal bandwidth (SBW) of the RF front-end is the maximum value among all intermediate frequency signal bandwidths in the RF front-end; the frequency interval value (FIV) between two adjacent channels is the absolute value of the difference between the center frequency of a channel and the center frequency of its adjacent channel; the frequency drift value (FDV) of the RF filter over the full temperature range is the product of the difference between the highest operating temperature and the lowest operating temperature (called DT), the frequency temperature coefficient (called TCF) of the RF filter, and the center frequency (f_{g}) of the RF filter, i.e., FDV=DT*TCF*f_{g}. That is also equal to the sum of the absolute value of the drift towards the high-frequency direction (FDV1) and the absolute value of the drift towards the low-frequency direction (FDV2) of the RF filter's center frequency over the full temperature range due to different operating temperatures.

In one or more embodiments, in step S12, based on the obtained working bandwidth (BW) of each RF filter, the RF filters are arranged in sequence from the starting frequency (f_{RFL}) to the ending frequency (f_{RFH}) of the RF working band, so that the working bandwidths of all RF filters cover all channels of the RF front-end and just continuously and completely cover the RF working band from the starting frequency (f_{RFL}) to the ending frequency (f_{RFH}). The working bandwidths of adjacent two RF filters are designed with an overlapping region, and the overlap bandwidth (Y) equals the sum of the intermediate frequency (IF) signal bandwidth (SBW) of the RF front-end and the frequency drift value (FDV) of the RF filter over the full temperature range.

In step S12, after the RF working band is determined, it is known that the starting frequency of the RF working band is f_{RFL}, the ending frequency of the RF working band is f_{RFH}, the intermediate frequency signal bandwidth of the RF front-end is SBW, the difference between the highest operating temperature and the lowest operating temperature of the RF filter over the operating temperature range is DT, the frequency temperature coefficient of the RF filter is TCF, and the relative bandwidth of the RF filter corresponding to the working frequency is RBW. It is assumed that N RF filters are needed to cover the RF working band (N is a positive integer≥2). To ensure continuous coverage of the RF working band (the working frequency is from f_{RFL} to f_{RFH}), the working bandwidths of two adjacent RF filters need to have an overlapping region. And the overlap bandwidth (Y) is no less than (i.e., is greater than or equal to) the sum of the intermediate frequency (IF) signal bandwidth (SBW) of the RF front-end and the frequency drift value (FDV) of the RF filter over the full temperature range. In one or more embodiments of the present application, the overlap bandwidth (Y) is set exactly equal to the sum of the intermediate frequency signal bandwidth (SBW) of the RF front-end and the frequency drift value (FDV) of the RF filter over the full temperature range.

In one or more embodiments, in step S13, according to the arrangement and coverage of each RF filter in S12, the number of RF filters required to continuously and completely cover the RF working band from f_{RFL} to f_{RFH} is calculated, and the center frequency f_{g} of each RF filter is calculated.

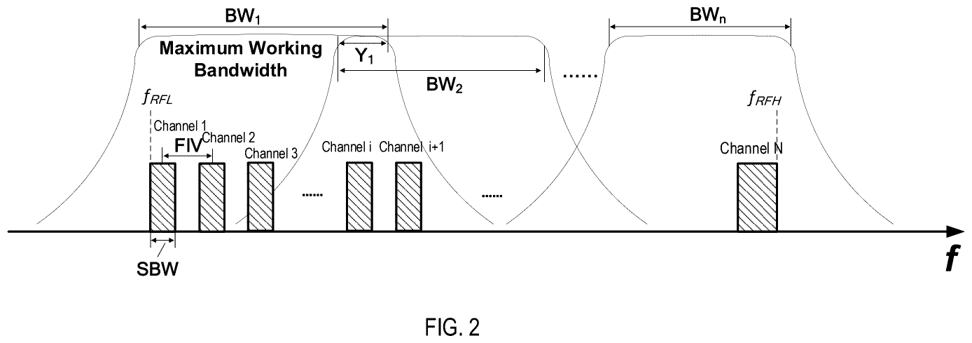

Furthermore, in step S13, as shown in FIG. 2, the specific operations of calculating the number (N) of RF filters are as follows.

First, because the relative bandwidth (RBW) of the RF filter is the percentage of the absolute bandwidth (BW) of the RF filter to the center frequency (f_{g}) of the RF filter, the absolute bandwidth (BW) of the RF filter is:

$$B W = R B W * ( {f}_{R F L} + \frac{B W}{2} ) .$$

Then we can get

$$BW = \frac{2 R B W}{2 - RBW} * {f}_{R F L} ,$$

which is denoted as Equation (1).

From Equation (1), the working bandwidth of the first RF filter (101) can be obtained as:

$$B {W}_{1} = \frac{2 R B {W}_{1}}{2 - R B {W}_{1}} * {f}_{RFL} ,$$

where RBW₁ is the relative bandwidth of the first RF filter (101), and BW₁ must be greater than the sum of the intermediate frequency signal bandwidth (SBW) of the RF front-end and the frequency drift value (FDV) of the first RF filter 101 over the full temperature range.

Then, the working bandwidth (BW₂) of the second RF filter (102) is calculated as:

$$B {W}_{2} = \frac{2 R B {W}_{2}}{2 - R B {W}_{2}} * ( {f}_{R F L} + B {W}_{1} - {Y}_{1} ) ,$$

where Y₁ is the bandwidth of the overlapping region between the working bandwidths of the first RF filter (101) and the second RF filter (102).

Similarly, for the i-th RF filter (10i), its working bandwidth (BWᵢ) can be calculated as:

$$B {W}_{i} = R B {W}_{i} * ( {f}_{R F L} + B {W}_{1} + B {W}_{2} + … + \frac{B {W}_{i}}{2} - {Y}_{1} - {Y}_{2} - … - {Y}_{i - 1} ) ,$$

which yields

$$B {W}_{i} = \frac{2 R B {W}_{i}}{2 - R B {W}_{i}} * [ {f}_{R F L} + {\sum }_{k = 1}^{i - 1} ( B {W}_{k} - {Y}_{k} ) ] ,$$

where i is a positive integer greater than 2.

Preferably, the bandwidth of each overlapping region (Y) is designed as the sum of the intermediate frequency signal bandwidth (SBW) of the RF front-end and the frequency drift value (FDV) of the RF filter over the full temperature range (assuming that the frequency drift values (FDV) of each RF filters over the full temperature range is equal), i.e., Y₁=Y₂= . . . =Yᵢ₋₁=Y=SBW+FDV.

Therefore, the working bandwidth of the i-th RF filter (10i) is:

$${BW}_{i} = \frac{2 R B {W}_{i}}{2 - R B {W}_{i}} * [ {f}_{R F L} + {\sum }_{k = 1}^{i - 1} B {W}_{k} - ( i - 1 ) * Y ] .$$

By analogy, when the working bandwidth (BW_{N}) of the N-th RF filter (10N) is calculated, if the condition is met that the low-end cutoff frequency of the N-th RF filter (10N) is less than the ending frequency (f_{RFH}) of the RF working band and the high-end cutoff frequency of the N-th RF filter (10N) is greater than or equal to the ending frequency (f_{RFH}) of the RF working band, i.e., the conditions

$${f}_{R F L} + {\sum }_{k = 1}^{N - 1} ( {BW}_{k} - {Y}_{k} ) < {f}_{R F H} and$$

$${f}_{R F L} + {\sum }_{k = 1}^{N - 1} ( B {W}_{k} - {Y}_{k} ) + B {W}_{N} \geq {f}_{R F H}$$

hold true, then N is the number of RF filters required to cover the RF working band.

Notably, the bandwidths of the first and last filters need to be widened to account for temperature-induced frequency drift. The low-end cutoff frequency of the first filter must be lower than the starting frequency of the RF working band (f_{RFL}), while the high-end cutoff frequency of the last filter must be higher than the terminating frequency of the RF working band (f_{RFH}). The specific widening values are determined by the frequency drift caused by temperature variations. For example, if the filter frequencies shift as a whole toward the lower end by 10 MHz at the minimum operating temperature, then the low-end cutoff frequency of the first filter must be at least 10 MHz lower than the starting frequency of the RF working band. Conversely, if the filter frequencies shift as a whole toward the higher end by 8 MHz at the maximum operating temperature, then the high-end cutoff frequency of the last filter must be at least 8 MHz higher than the ending frequency of the RF working band (f_{RFH})

Moreover, the center frequency (f_{g}) of the RF filter can be calculated based on the absolute bandwidth (BW) of each RF filter, the starting frequency (f_{RFL}) of the RF working band, and the ending frequency (f_{RFH}) of the RF working band, which will not be repeated here.

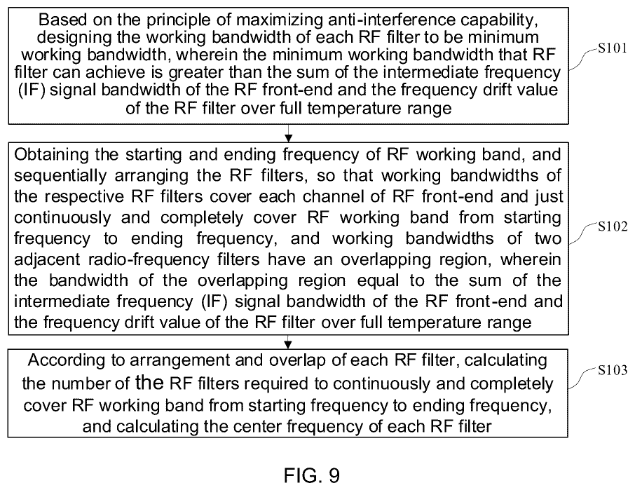

In one or more embodiments of the present application, as shown in FIG. 9, determining the working bandwidth, number, and center frequency of the required RF filters according to the RF working band further includes:
Step S101: based on the principle of maximizing anti-interference capability, designing working bandwidth of each RF filter to be minimum working bandwidth, wherein the minimum working bandwidth that RF filter can achieve is greater than the sum of the intermediate frequency (IF) signal bandwidth of the RF front-end and the frequency drift value of the RF filter over the full temperature range;
Step S102: obtaining the starting and ending frequency of RF working band, and sequentially arranging the RF filters, so that working bandwidths of the respective RF filters cover each channel of the RF front-end and just continuously and completely cover the RF working band from the starting frequency to the ending frequency, and working bandwidths of two adjacent RF filters have an overlapping region, wherein the bandwidth of the overlapping region is equal to the sum of the intermediate frequency (IF) signal bandwidth of the RF front-end and the frequency drift value of the RF filter over the full temperature range; and
Step S103: according to the arrangement and overlap of each RF filter, calculating the number of the RF filters required to continuously and completely cover RF working band from the starting frequency to the ending frequency, and calculating the center frequency of each RF filter.

In one or more embodiments, in step S101, based on the principle of maximizing anti-interference capability, the working bandwidth (BW) of each RF filter is designed as the minimum working bandwidth. The working bandwidth (BW) of each RF filter can be the same or different.

It should be noted that there are three situations for the value of the minimum working bandwidth of the RF filter.

1) In the first situation, when the minimum bandwidth that the RF filter can achieve is greater than the sum of the intermediate frequency signal bandwidth (SBW) of the RF front-end, the frequency interval value (FIV) between two adjacent channels, and the frequency drift value (FDV) of the RF filter over the full temperature range, the minimum working bandwidth of the RF filter is designed to be the minimum bandwidth that the RF filter can achieve.

2) In the second situation, when the minimum bandwidth that the RF filter can achieve is less than or equal to the sum of SBW, FIV, and FDV, but greater than the sum of SBW and FDV, the minimum working bandwidth of the RF filter is designed to be the sum of SBW, FIV and FDV.

3) In the third situation, when the minimum bandwidth that the RF filter itself can achieve is less than or equal to the sum of SBW and FDV, then in the subsequent step S102, the arrangement design results in adjacent RF filters' working bandwidths having no overlap region. This will be detailed further in another optional embodiment of the invention.

In one or more embodiments, in step S102, based on the obtained working bandwidth (BW) of each RF filter, the RF filters are arranged in sequence from the starting frequency (f_{RFL}) to the ending frequency (f_{RFH}) of the RF working band, so that the working bandwidths of all RF filters cover all channels of the RF front-end and just continuously and completely cover the RF working band from the starting frequency (f_{RFL}) to the ending frequency (f_{RFH}). Assuming that N RF filters are needed to cover the RF working band (N is a positive integer 2), to ensure that the RF working band (the working frequency is from the starting frequency (f_{RFL}) to the ending frequency (f_{RFH})) is continuously covered, the working bandwidths of two adjacent RF filters need to have an overlapping region, and the overlap bandwidth (Y) is no less than (i.e., is greater than or equal to) the sum of SBW and FDV. For example, the overlap bandwidth (Y) is just set to the sum of SBW and FDV.

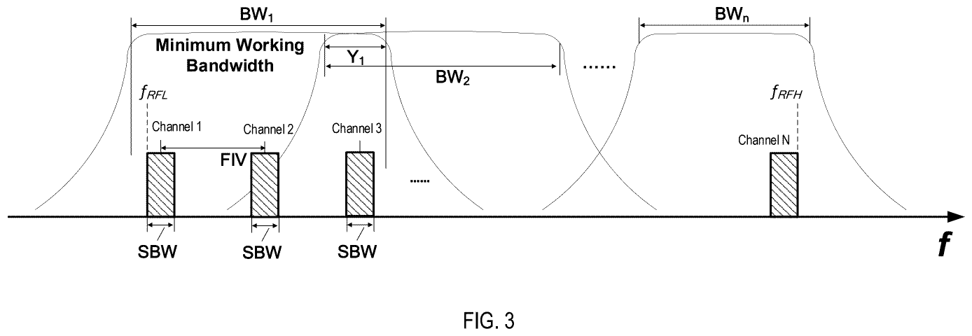

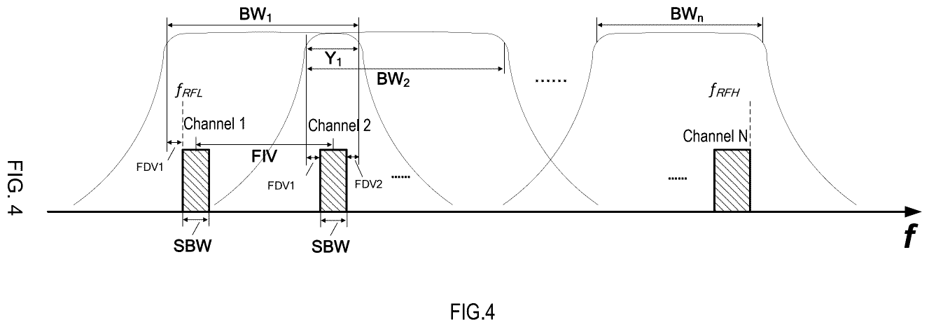

Further, in step S102, as shown in FIG. 3, when the minimum bandwidth that the RF filter itself can achieve is greater than the sum of SBW, FIV and FDV, the minimum working bandwidth of the RF filter is designed to be the minimum bandwidth that the RF filter can achieve. Compared with the embodiment shown in FIG. 2, due to the reduction of its bandwidth, the number of RF frequency bands or channels that it can cover is smaller; in step S102, as shown in FIG. 4, when the minimum bandwidth that the RF filter itself can achieve is less than or equal to the sum of SBW, FIV and FDV but greater than the sum of SBW and FDV, the minimum working bandwidth of the RF filter is designed to be the sum of SBW, FIV and FDV. Compared with the embodiments shown in FIGS. 2 and 3, due to the further reduction of its bandwidth, the RF frequency band range that it can cover is further reduced, or the number of channels is further reduced. However, it can at least completely cover one channel.

In one or more embodiments, in step S103, according to the arrangement and coverage of each RF filter in step S102, the number of RF filters required to continuously and completely cover the RF working band from the starting frequency (f_{RFL}) to the ending frequency (f_{RFH}) is calculated, and the center frequency (f_{g}) of each RF filter is calculated. For the specific calculation process, please refer to the description of the aforementioned embodiment (for example, in paragraphs [0029]-[0036]), which will not be repeated here.

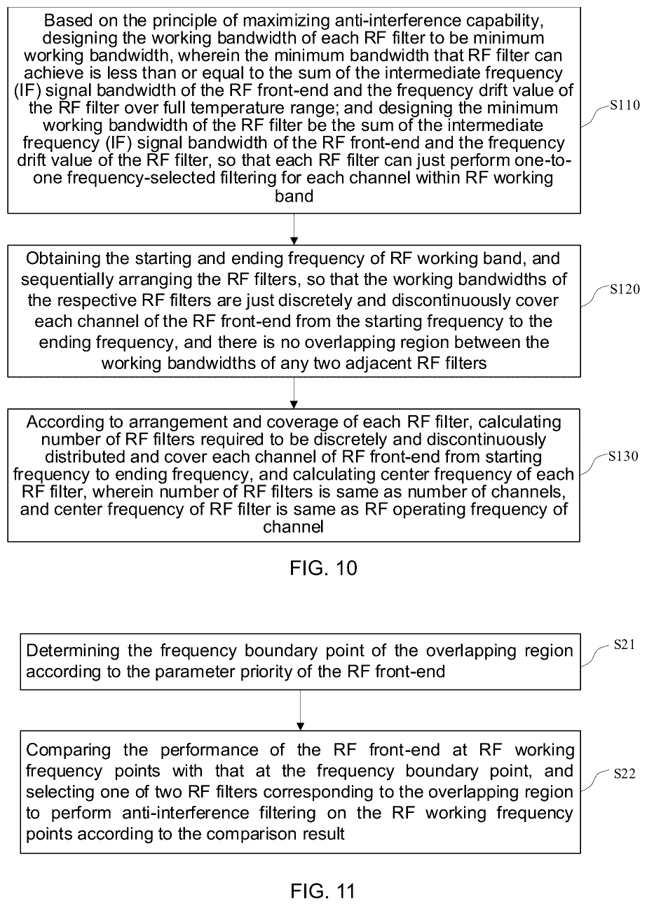

In one or more embodiments, in step S1, for the third situation of the minimum working bandwidth of the RF filter, when the minimum bandwidth that the RF filter itself can achieve is less than or equal to the sum of SBW and FDV, in one or more embodiments of the present application, as shown in FIG. 10, the steps of determining the working bandwidth, number, and center frequency of the required RF filters based on the RF working band are further included:
Step S110: based on the principle of maximizing anti-interference capability, designing working bandwidth of each RF filter to be minimum working bandwidth, wherein the minimum bandwidth that RF filter can achieve is less than or equal to the sum of the intermediate frequency (IF) signal bandwidth of the RF front-end and the frequency drift value of the RF filter over the full temperature range; and designing the minimum working bandwidth of the RF filter be the sum of the intermediate frequency (IF) signal bandwidth of the RF front-end and the frequency drift value of the RF filter, so that each RF filter can just perform one-to-one frequency-selected filtering for each channel within RF working band;
Step S120: obtaining the starting and ending frequency of RF working band, and sequentially arranging the RF filters, so that the working bandwidths of the respective RF filters are just discretely and discontinuously cover each channel of the RF front-end from the starting frequency to the ending frequency, and there is no overlapping region between the working bandwidths of any two adjacent RF filters; and
Step S130: according to arrangement and coverage of each RF filter, calculating the number of the RF filters required to discretely and discontinuously cover each channel of the RF front-end from the starting frequency to the ending frequency, and calculating the center frequency of each RF filter, wherein the number of the RF filters is same as the number of the channels, and the center frequency of the RF filter is same as the RF center frequency of the channel.

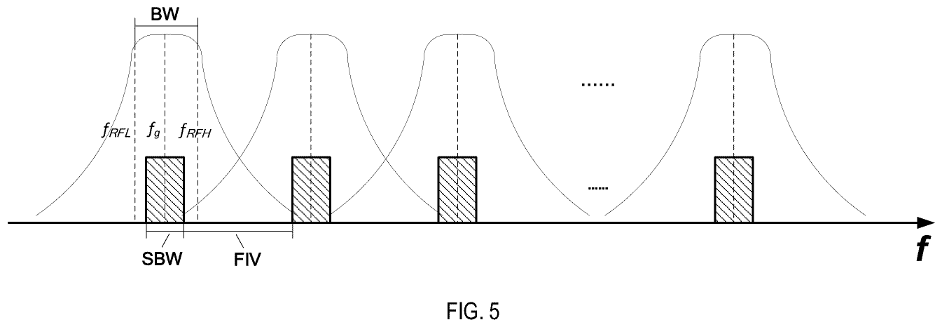

In one or more embodiments, in steps S110 to S130, for the third situation of the minimum working bandwidth of the RF filter, when the minimum bandwidth that the RF filter itself can achieve is less than or equal to the sum of SBW and FDV, the minimum working bandwidth of the RF filter is designed to be the sum of SBW and FDV. This ensures that each RF filter can perform selective filtering on exactly one channel within the RF working band. In this case, because generally the frequency interval value (FIV) between two adjacent channels is generally greater than the intermediate frequency signal bandwidth (SBW) of the RF front-end, the working bandwidths of two adjacent RF filters have no overlapping region. as shown in FIG. 5. The RF filter cannot achieve continuous coverage of the RF working band, and the working bandwidths of all RF filters are distributed discretely and discontinuously, and each RF filter performs one-to-one frequency-selected filtering on each channel. The number of RF filters is the same as the number of the channels within the RF working band, and the center frequency of the RF filter is the same as the RF working frequency corresponding to the channel.

It should be noted that if the number of RF filters (N) calculated in S1 is equal to 2ⁿ or 2ⁿ−i, the calculated value is set as the final value of the number of RF filters; if the calculated number of RF filters (N) is equal to 2ⁿ+j, the number of RF filters is reduced by adjusting the center frequency and the working bandwidth of at least one RF filter, so that the final value of the number of RF filters is equal to 2ⁿ, wherein n, i and j are all positive integers greater than 1.

In one or more embodiments, the final design of each RF filter must be combined with multiple RF switches to form a switch-filter circuit, where the RF switches select and connect different filters, and the “1-to-N” RF switch is mainly designed as a 1-to-2ⁿ switch, such as 1-to-2, 1-to-4, 1-to-8, etc. Therefore, to improve the utilization efficiency of the RF switch's switching channels, avoid creating many idle positions and wasting resources, and further reduce the insertion loss of the overall switch-filter circuit, the number of RF filters N should ideally be equal to or slightly less than a power of two (i.e., 2\hat{ }n), such as 8, 16, 32, etc., or 7, 15, 30, 31, etc. In this case, the final value of N is taken as the calculated value, resulting in high utilization efficiency of the RF switch's switching channels. If the calculated number of RF filters N is slightly greater than a power of two (i.e., 2\hat{ }n), then the working bandwidth of at least one RF filter should be widened to reduce the number of RF filters, for example, by moving the center frequency of a certain filter or multiple filters toward higher frequencies and increasing their respective working bandwidths to reduce the number of RF filters to a power of two (i.e., 2\hat{ }n). However, this adjustment method is not applicable in the case of the anti-interference maximization method, where each RF filter corresponds one-to-one with each RF channel for selective filtering.

In one or more embodiments, in step S2, for the situation shown in FIGS. 2-4, when the working bandwidths of two adjacent RF filters in the switch-filter circuit overlap, for RF working frequency points within this overlapping region, one of the two corresponding RF filters is selected based on the RF front-end parameter priority to perform interference filtering on the RF working frequency point.

Among the two RF filters corresponding to the overlapping region, the one with the lower center frequency is called the low-frequency RF filter, and the one with the higher center frequency is called the high-frequency RF filter. Within the frequency range where the working bandwidth of the low-frequency RF filter intersects with that of the high-frequency RF filter, it is determined for each RF working frequency point whether to use the low-frequency RF filter or the high-frequency RF filter.

Generally, as the working frequency of an RF filter moves away from its center frequency (either towards lower or higher frequencies), the performance of the RF filter gradually degrades, meaning that the performance near the filter's cutoff frequencies is relatively worse than at the center frequency. Therefore, in step S2, a frequency boundary point can first be determined. The performance of the RF front-end at the RF working frequency boundary point is compared with its performance at the frequency boundary point. Based on the comparison of performance, it is determined for each RF working frequency point whether to use the low-frequency RF filter or the high-frequency RF filter.

Based on this, in an optional embodiment of the present application, as shown in FIG. 11, for the RF working frequency point in the overlapping region, the step S2 of selecting one of the two RF filters to perform anti-interference filtering on the RF working frequency point according to a parameter priority of the RF front-end may further include:
Step S21: determining the frequency boundary point of the overlapping region according to the parameter priority of the RF front-end; and
Step S22: comparing the performance of RF front-end at RF working frequency points with that at the frequency boundary point, and selecting one of two RF filters corresponding to the overlapping region to perform anti-interference filtering on the RF working frequency points according to the comparison result.

In one or more embodiments, in steps S21-S22, select the RF Filter for the RF working frequency in the overlap region based on the RF front-end parameter priority. First, determine the frequency boundary point in the overlap region based on the RF front-end parameter priority. As the RF filter's working frequency moves away from its center frequency (in either the lower or higher direction), its performance gradually degrades. Therefore, an intermediate point within the overlap region, where the performance of both RF filters (i.e., the low-frequency RF filter and the high-frequency RF filter mentioned before) has deteriorated to a certain extent, can be identified as the frequency boundary point. Next, compare the performance of the RF front-end at the RF working frequency with its performance at the frequency boundary point. Based on this comparison, select to use the low-frequency RF filter or low-frequency RF filter; Within the overlap region, as the RF working frequency increases from its minimum value, the low-frequency RF filter's filtering performance within its passband gradually deteriorates, while the high-frequency RF filter's filtering performance within its passband gradually improves. The critical point where the performance shifts from deteriorating to improving is the frequency boundary point. Therefore, if the RF working frequency is less than the frequency boundary point, then select the low-frequency RF filter with the lower center frequency for interference filtering; if the RF working frequency is greater than or equal to the frequency boundary point, then select the high-frequency RF filter with the higher center frequency for interference filtering. This ensures that the performance of the RF front-end at the corresponding RF working frequency is always higher than or equal to its performance at the frequency boundary point.

In one or more embodiments, depending on different filtering requirements in different electronic systems or RF front-ends, the frequency boundary point of the overlapping region can be obtained according to the different parameter priorities of the RF front-end to meet the differentiated filtering requirements. The different parameter priorities of the RF front-end can be signal amplitude priority, signal phase priority, and signal delay priority, or they can be signal modulation method priority, or they can be a comprehensive priority of multiple parameters.

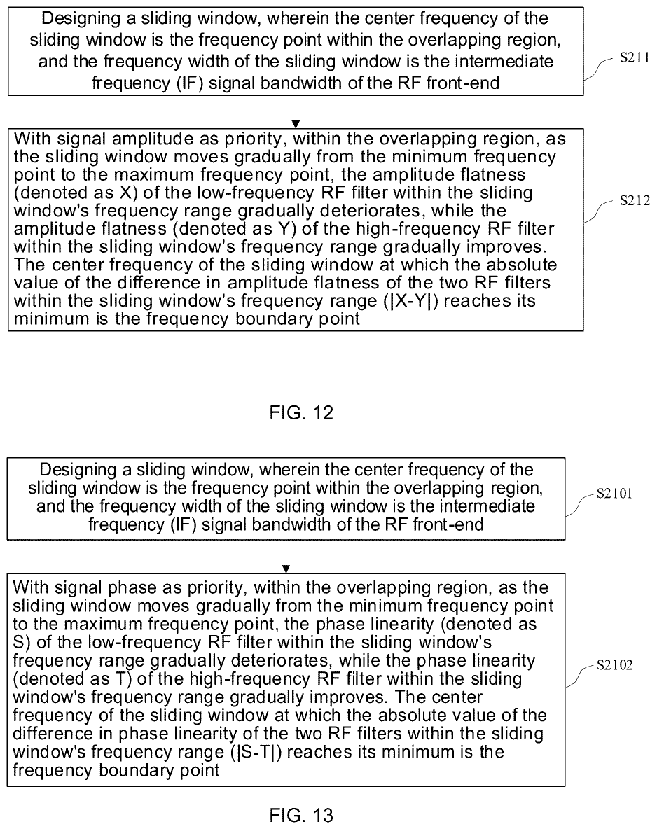

In one or more embodiments of the present application, the signal amplitude from the electronic system or RF front-end is prioritized to obtain the frequency boundary point in the overlapping region. In step S2, as shown in FIG. 12, the step S21 of determining the frequency boundary point of the overlapping region according to the parameter priority of the RF front-end further includes:
Step S211: designing a sliding window, wherein the center frequency of the sliding window is the frequency point within the overlapping region, and the frequency width of the sliding window is the intermediate frequency (IF) signal bandwidth of the RF front-end; and
Step S212: with signal amplitude as priority, within the overlapping region, as the sliding window moves gradually from the minimum frequency point to the maximum frequency point, the amplitude flatness (denoted as X) of the low-frequency RF filter within the sliding window's frequency range gradually deteriorates, while the amplitude flatness (denoted as Y) of the high-frequency RF filter within the sliding window's frequency range gradually improves. The center frequency of the sliding window at which the absolute value of the difference in amplitude flatness of the two RF filters within the sliding window's frequency range (|X−Y|) reaches its minimum is the frequency boundary point.

In one or more embodiments, in steps S211-S212, the signal amplitude of the electronic system or the RF front-end is prioritized, and the amplitude flatness (i.e., fluctuation) of the corresponding two RF filters within the frequency range of the overlapping region is evaluated to determine the frequency boundary point, and the specific evaluation process is based on simulation results or measured data results. In one or more embodiments, when the sliding window gradually slides from the minimum frequency point to the maximum frequency point within the overlapping frequency range, its sliding frequency increment can be set according to the frequency interval value (FIV) between two adjacent channels. For example, the increment can be set as 1 kHz, 10 kHz, 100 kHz, 1 MHz, 10 MHz, etc.

In one or more embodiments of the present application, the signal phase from the electronic system or RF front-end is prioritized to obtain the frequency boundary point in the overlapping region. In step S2, as shown in FIG. 13, the step S21 of determining the frequency boundary point of the overlapping region according to the parameter priority of the RF front-end further includes:
Step S2101: designing a sliding window, wherein the center frequency of the sliding window is the frequency point within the overlapping region, and the frequency width of the sliding window is the intermediate frequency (IF) signal bandwidth of the RF front-end; and
Step S2102: with signal phase as priority, within the overlapping region, as the sliding window moves gradually from the minimum frequency point to the maximum frequency point, the phase linearity (denoted as S) of the low-frequency RF filter within the sliding window's frequency range gradually deteriorates, while the phase linearity (denoted as T) of the high-frequency RF filter within the sliding window's frequency range gradually improves. The center frequency of the sliding window at which the absolute value of the difference in phase linearity of the two RF filters within the sliding window's frequency range (|S−T|) reaches its minimum is the frequency boundary point.

In one or more embodiments, in steps S2101-S2102, the signal phase of the electronic system or the RF front-end is prioritized, and the phase linearity of the corresponding two RF filters within the frequency range of the overlapping region is evaluated to determine the frequency boundary point, and the specific evaluation process is based on simulation results or measured data results

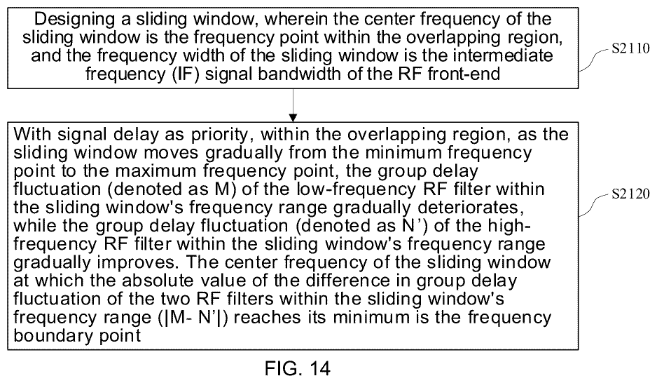

In one or more embodiments of the present application, the signal delay from the electronic system or RF front-end is prioritized to obtain the frequency boundary point in the overlapping region. In step S2, as shown in FIG. 14, the step S21 of determining the frequency boundary point of the overlapping region according to the parameter priority of the RF front-end further includes:
Step S2110: designing a sliding window, wherein the center frequency of the sliding window is the frequency point within the overlapping region, and the frequency width of the sliding window is the intermediate frequency (IF) signal bandwidth of the RF front-end; and
Step S2120: with signal delay as priority, within the overlapping region, as the sliding window moves gradually from the minimum frequency point to the maximum frequency point, the group delay fluctuation (denoted as M) of the low-frequency RF filter within the sliding window's frequency range gradually deteriorates, while the group delay fluctuation (denoted as N′) of the high-frequency RF filter within the sliding window's frequency range gradually improves. The center frequency of the sliding window at which the absolute value of the difference in group delay fluctuation of the two RF filters within the sliding window's frequency range (|M−N′|) reaches its minimum is the frequency boundary point.

In one or more embodiments, in steps S2110 to S2120, the signal delay of the electronic system or the RF front-end is prioritized, and the group delay fluctuation of the corresponding two RF filters within the frequency range of the overlapping region is evaluated to determine the frequency boundary point, and the specific evaluation process is based on simulation results or measured data results.

In one or more embodiments of the present application, the frequency boundary point can also be determined according to the modulation mode of the signal transmitted in the system channel. Specifically, first, a sliding window is designed in the same way, with the center frequency of the sliding window being a frequency point within the overlap region and the frequency width of the sliding window being the IF signal bandwidth of the RF front-end; then move the sliding window gradually from the minimum to the maximum value of the overlap region frequency range, and feed the input signal with the target modulation mode (which can be MSK, ASK, FSK, QAM, etc.) into both the low-frequency RF filter and the high-frequency RF filter using the sliding window frequency information; then check the output signal quality through simulation or testing, and as the sliding window moves, the signal quality of the low-frequency RF filter within the sliding window frequency range will gradually deteriorates, and the signal quality of the high-frequency RF filter within the sliding window frequency range will gradually improves; when the signal quality of both reaches the closest state, the center frequency of the sliding window is the frequency boundary point. Specifically, the signal quality can be judged by checking the technical indicators such as the signal-to-noise ratio (SNR) or error vector magnitude (EVM) of the output signal.

Additionally, the electronic systems or the RF front-ends that prioritize other signal parameters can also be considered, and the frequency boundary point can be determined based on the priority of other signal parameters. The specific determination process is similar to the above-mentioned process based on signal amplitude priority, signal phase priority, and signal delay priority. It can also be similar to the process that prioritizes the signal modulation, which will not be repeated here. Multiple parameters (A, B, C . . . ) can also be considered comprehensively and sorted according to priority to determine the frequency boundary point. For example, multiple parameters (A, B, C) can be signal amplitude, signal phase and SNR. Specifically, first, each parameter (A, B, C . . . ) is sorted according to priority, and using the above-mentioned principle method to determine the frequency boundary point corresponding to each parameter after sorting, and then determine the final frequency boundary point from the obtained frequency boundary points based on the demand analysis on the indicators of the electronic system or RF front-end to achieve the optimal state.

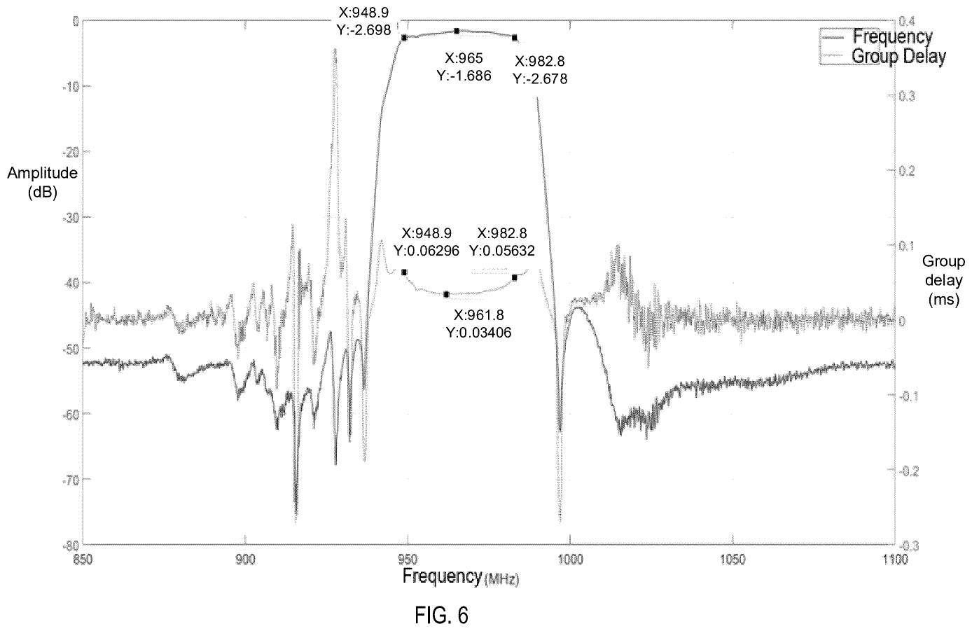

It should be noted that the RF filters in the present invention may be acoustic filters. Acoustic filters are RF filters implemented using acoustic resonators, and they possess advantages such as being thin, lightweight, low insertion loss, high shape factor, and low temperature coefficient. Common types of acoustic filters include Surface Acoustic Wave (SAW) filters and Film Bulk Acoustic Resonator (FBAR) filters. Within the passband of an acoustic filter, there exists an inconsistency in RF performance between the lower sideband near the low cutoff frequency and the upper sideband near the high cutoff frequency. FIG. 6 illustrates the curve of S21 (insertion loss) versus frequency and the group delay versus frequency for an acoustic filter with a center frequency of 965 MHz. As shown in FIG. 6, the group delay fluctuation on both sides of the passband of this acoustic filter is inconsistent. Given the characteristic of inconsistent group delay fluctuation on both sides of the passband of acoustic filters, for systems prioritizing group delay fluctuation, the frequency boundary point of the switch-filter circuit composed of acoustic filters in the RF front-end can be determined through a similar method as described above, thereby achieving an optimal state of system anti-interference filtering.

Therefore, when determining the frequency boundary point, the parameters to be prioritized can be flexibly selected according to the parameter performance differences of the corresponding RF filters to meet different filtering requirements.

It is understood that in one or more embodiments of the present application, the frequency boundary point may also be left undetermined, and instead, different RF frequency bands in the overlapping region are directly divided, with different RF frequency bands being assigned to different RF filters. For example, one segment belongs to an RF filter with a higher center frequency, another segment belongs to a RF filter with a lower center frequency, yet another segment belongs to a RF filter with a higher center frequency, and still another segment belongs to a RF filter with a lower center frequency, etc., which will not be repeated here.

Additionally, the overlap region can be divided into several segments based on filtering performance requirements, with each segment belonging to either the low-frequency RF filter or the high-frequency RF filter. For example, if the low-frequency RF filter has better filtering performance than the high-frequency RF filter in the first segment, then the first segment is assigned to the low-frequency RF filter. If the high-frequency RF filter has better filtering performance than the low-frequency RF filter in the second segment, then the second segment is assigned to the high-frequency RF filter, and so on, thereby confirming which filter each working frequency point within the overlap region belongs to.

In one or more embodiments, in step S3, based on the situations shown in FIGS. 2-5, for a certain RF working frequency point, if it falls within other regions of the RF filter's bandwidth except the overlap region, then select the corresponding RF filter to perform anti-interference filtering processing on this RF working frequency point, i.e., RF working frequency points in non-overlap regions select the RF filter whose bandwidth covers this RF working frequency point for anti-filtering.

In one or more embodiments of the present application, a RF front-end module is provided, which includes a switch-filter circuit prepared under the guidance of the method for segmenting RF front-end anti-interference filtering described in any of the above items, and it can flexibly design the required operating parameters of the RF filter according to the RF working band to be covered, and can reversely guide the design of the RF filter. The prepared RF filters constitute a switch-filter circuit, and based on the customization of each RF filter, the optimal customized filtering performance of the RF front-end switch-filter circuit is achieved, thereby improving the filtering accuracy of the RF front-end switch-filter circuit.

It should be noted that the RF front-end module is a miniaturized module in which multiple chips such as switches, RF filters, amplifiers, phase shifters, etc., are assembled through 2D, 2.5D, or 3D heterogeneous integration processes. It can also be a SoC single chip that integrates one or all of the circuits, or it can be other product forms. However, no matter what form it is, the switch-filter circuit it contains is manufactured under the guidance of the method for segmenting RF front-end anti-interference filtering described in any of the above items.

One or more embodiments of the present application also provide an electronic device, including: one or more processors; a storage device for storing one or more programs, when one or more programs are executed by one or more processors, the electronic device implements the method for segmenting RF front-end anti-interference filtering provided in the above-mentioned embodiments.

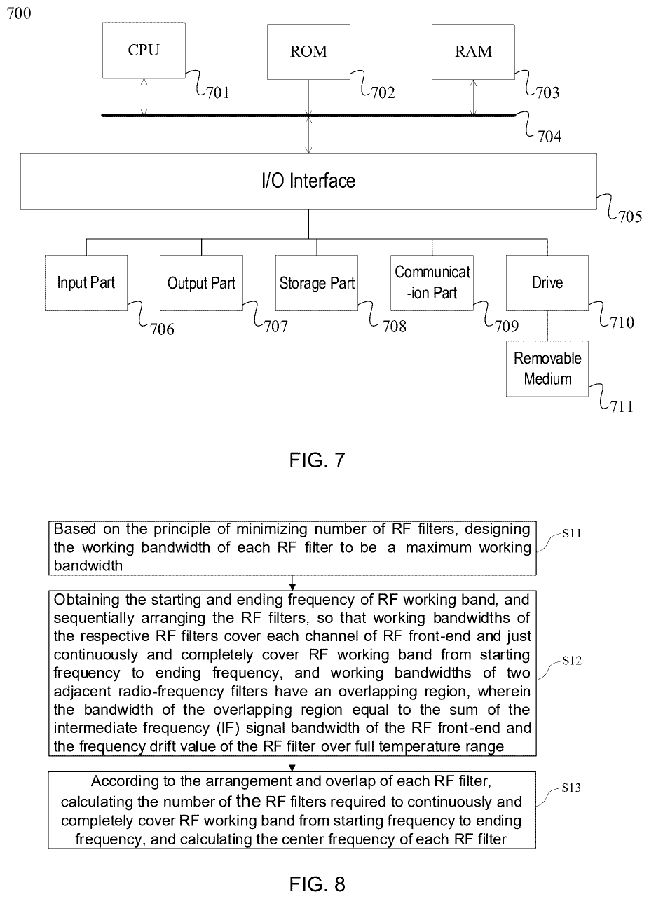

FIG. 7 shows a schematic diagram of the structure of a computer system 700 of an electronic device suitable for implementing the embodiment of the present application. It should be noted that the computer system 700 of the electronic device shown in FIG. 7 is only an example and should not bring any limitation to the functions and scope of use of the embodiment of the present application.

As shown in FIG. 7, the computer system 700 includes a central processing unit (CPU) 701, which can perform various appropriate actions and processes according to a program stored in a read-only memory (ROM) 702 or a program loaded from a storage part 708 to a random access memory (RAM) 703, such as execute the method described in the above embodiment. Various programs and data required for system operation are also stored in the RAM 703. The CPU 701, the ROM 702, and the RAM 703 are connected to each other via a bus 704. An input/output (I/O) interface 705 is also connected to the bus 704.

The following components are connected to the I/O interface 705: an input part 706 including a keyboard, a mouse, etc.; an output part 707 including a cathode ray tube (CRT), a liquid crystal display (LCD), etc., and a speaker, etc.; a storage part 708 including a hard disk, etc.; and a communication part 709 including a network interface card such as a LAN (Local Area Network) card, a modem, etc. The communication part 709 performs communication processing via a network such as the Internet. A drive 710 is also connected to the I/O interface 705 as needed. A removable medium 711, such as a magnetic disk, an optical disk, a magneto-optical disk, a semiconductor memory, etc., is installed on the drive 710 as needed so that a computer program read therefrom is installed into the storage part 708 as needed.

In particular, according to an embodiment of the present application, the process described above can be implemented as a computer software program. For example, an embodiment of the present application includes a computer program product, which includes a computer program carried on a computer-readable medium, and the computer program includes a computer program for executing the method shown in the flowchart. In such an embodiment, the computer program can be downloaded and installed from the network through the communication part 709, and/or installed from the removable medium 711. When the computer program is executed by the central processing unit (CPU) 701, various functions defined in the system of the present application are executed.

It should be noted that the computer-readable medium shown in the embodiment of the present application may be a computer-readable signal medium, a computer-readable storage medium or any combination of the above two. The computer-readable storage medium may be, for example, an electrical, magnetic, optical, electromagnetic, infrared, or semiconductor system, device, or means, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM), a flash memory, an optical fiber, a portable compact disk read-only memory (CD-ROM), an optical storage device, a magnetic storage device, or any suitable combination of the above. In the present application, a computer-readable signal medium may include a data signal propagated in a baseband or as part of a carrier wave, which carries a computer-readable computer program. This propagated data signal may take a variety of forms, including but not limited to an electromagnetic signal, an optical signal, or any suitable combination of the above. A computer-readable signal medium may also be any computer-readable medium other than a computer-readable storage medium, which may send, propagate, or transmit a program for use by or in conjunction with an instruction execution system, apparatus, or device. A computer program contained on a computer-readable medium may be transmitted using any suitable medium, including but not limited to: wireless medium, wired medium, etc., or any suitable combination of the above.

One or more embodiments of the present application further provide a computer-readable storage medium on which a computer program is stored, and when the computer program is executed by a processor, the method for segmenting RF front-end anti-interference filtering as described above is implemented. The computer-readable storage medium may be included in the electronic device described in the above embodiment or may exist independently without being assembled into the electronic device.

One or more embodiments of the present application further provide a computer program product or a computer program, which includes a computer instruction stored in a computer-readable storage medium. A processor of a computer device reads the computer instruction from the computer-readable storage medium, and the processor executes the computer instruction so that the computer device executes the method for segmenting RF front-end anti-interference filtering provided in each of the above embodiments.

In summary, in the method for segmenting RF front-end anti-interference filtering, RF front-end module, electronic device, computer-readable storage medium, computer program product, or computer program provided by the present application, based on the principle of minimizing the number of RF filters or maximizing the anti-interference capability, the working bandwidth, number, and center frequency of the RF filter required for the switch-filter circuit are determined according to the RF working band, so that the operating parameters of the required RF filter can be flexibly designed according to the RF working band to be covered, so as to achieve tailor-made filtering performance with optimal performance, improve the filtering accuracy, and reversely guide the design of the RF filter; secondly, when there is an overlapping region in the working bandwidth of two RF filters with adjacent bandwidths in the switch-filter circuit, for the RF working frequency point in the overlapping region, one of the two RF filters corresponding to the overlapping region is selected according to the priority level for a parameter of the RF front-end to perform anti-interference filtering on the RF working frequency point, and the priority level for a parameter of the RF front-end can be flexibly selected and designed according to different filtering requirements of the RF front-end (that is, one of the two RF filters corresponding to the overlapping region is selected according to the different filtering requirements of the RF front-end to perform anti-interference filtering on the RF working frequency point), while achieving high-precision filtering, it can effectively take into account other performance requirements of the RF front-end or the electronic system, and further achieve directional and precise filtering.

The above embodiments are merely illustrative of the principles and effects of the present application, and are not intended to limit the present application. Anyone familiar with the technology may modify or change the above embodiments without departing from the scope of the present application. Therefore, all equivalent modifications or changes made by a person of ordinary skill in the art without departing from the technical concept disclosed by the present application should still be covered by the claims of the present application.

What is claimed is:

1. A method for segmenting RF front-end anti-interference filtering, comprising:
obtaining a RF working band to-be-covered of a RF front-end, and determining working bandwidth, number, and center frequency of required RF filters according to the RF working band based on a principle of minimizing the number of RF filters or maximizing an anti-interference capability, so that the working bandwidth of a switch-filter circuit formed by all RF filters at least covers each channel of the RF front-end; and
when there is an overlapping region in the working bandwidths of two RF filters with adjacent bandwidths in the switch-filter circuit; for an RF working frequency point in the overlapping region, selecting one of the two RF filters to perform anti-interference filtering on the RF working frequency point according to a parameter priority of the RF front-end.

2. The method for segmenting RF front-end anti-interference filtering according to claim 1, wherein determining working bandwidth, number, and center frequency of required RF filters according to the RF working band includes:
based on the principle of minimizing the number of RF filters, designing the working bandwidth of each RF filter to be a maximum working bandwidth;
obtaining a starting frequency and an ending frequency of the RF working band, and sequentially arranging the RF filters, so that the working bandwidths of the respective RF filters cover each channel of the RF front-end and just continuously and completely cover the RF working band from the starting frequency to the ending frequency, and the working bandwidths of two adjacent RF filters have the overlapping region, wherein the bandwidth of the overlapping region is equal to a sum of an intermediate frequency signal bandwidth of the RF front-end and a frequency drift value of the RF filter over a full temperature range; and
according to arrangement and coverage of each RF filter, calculating the number of the RF filters required to continuously and completely cover the RF working band from the starting frequency to the ending frequency, and calculating the center frequency of each RF filter.

3. The method for segmenting RF front-end anti-interference filtering according to claim 2, wherein a maximum working bandwidth of the RF filter is greater than or equal to a sum of the intermediate frequency signal bandwidth of the RF front-end, a frequency interval value between two adjacent channels, and the frequency drift value of the RF filter over the full temperature range.

4. The method for segmenting RF front-end anti-interference filtering according to claim 1, wherein determining working bandwidth, number, and center frequency of required RF filters according to the RF working band includes:
based on a principle of maximizing the anti-interference capability, designing the working bandwidth of each RF filter to be a minimum working bandwidth, wherein the minimum working bandwidth that the RF filter can achieve is greater than a sum of an intermediate frequency signal bandwidth of the RF front-end and a frequency drift value of the RF filter over a full temperature range;
obtaining a starting frequency and an ending frequency of the RF working band, and sequentially arranging the RF filters, so that the working bandwidths of the respective RF filters cover each channel of the RF front-end and just continuously and completely cover the RF working band from the starting frequency to the ending frequency, and the working bandwidths of two adjacent RF filters have the overlapping region, wherein the bandwidth of the overlapping region is equal to a sum of the intermediate frequency signal bandwidth of the RF front-end and the frequency drift value of the RF filter over the full temperature range; and
according to arrangement and coverage of each RF filter, calculating the number of the RF filters required to continuously and completely cover the RF working band from the starting frequency to the ending frequency, and calculating the center frequency of each RF filter.

5. The method for segmenting RF front-end anti-interference filtering according to claim 4, wherein determining working bandwidth, number, and center frequency of required RF filters according to the RF working band includes:
when a minimum bandwidth that the RF filter can achieve is greater than a sum of the intermediate frequency signal bandwidth of the RF front-end, a frequency interval value between two adjacent channels, and the frequency drift value of the RF filter over the full temperature range, designing the minimum working bandwidth of the RF filter to be the minimum bandwidth that the RF filter can achieve; or
when the minimum bandwidth that the RF filter can achieve is less than or equal to the sum of the intermediate frequency signal bandwidth of the RF front-end, the frequency interval value between two adjacent channels, and the frequency drift value of the RF filter over the full temperature range, and greater than the sum of the intermediate frequency signal bandwidth of the RF front-end and the frequency drift value of the RF filter over the full temperature range, designing the minimum working bandwidth of the RF filter to be the sum of the intermediate frequency signal bandwidth of the RF front-end, the frequency interval value between two adjacent channels, and the frequency drift value of the RF filter over the full temperature range.

6. The method for segmenting RF front-end anti-interference filtering according to claim 1, wherein determining working bandwidth, number, and center frequency of required RF filters according to the RF working band includes:
based on a principle of maximizing the anti-interference capability, designing the working bandwidth of each RF filter to be a minimum working bandwidth, wherein a minimum bandwidth that the RF filter can achieve is less than or equal to a sum of an intermediate frequency signal bandwidth of the RF front-end and a frequency drift value of the RF filter over a full temperature range; and designing the minimum working bandwidth of the RF filter be the sum of the intermediate frequency signal bandwidth of the RF front-end and the frequency drift value of the RF filter over the full temperature range so that each RF filter just perform frequency-selected filtering on one channel within the RF working band;
obtaining a starting frequency and an ending frequency of the RF working band, and sequentially arranging the RF filters so that the working bandwidths of all RF filters are just discretely and discontinuously distributed from the starting frequency to the ending frequency and cover each channel of the RF front-end, and there is no overlapping region between the working bandwidths of two adjacent RF filters; and
according to arrangement and coverage of each RF filter, calculating the number of the RF filters required to be discretely and discontinuously distributed and cover each channel of the RF front-end from the starting frequency to the ending frequency, and calculating the center frequency of each RF filter, wherein the number of the RF filters is the same as the number of the channels, and the center frequency of the RF filter is the same as the RF working frequency of the channel.

7. The method for segmenting RF front-end anti-interference filtering according to claim 1, wherein selecting one of the two RF filters to perform anti-interference filtering on the RF working frequency point according to a parameter priority of the RF front-end includes:
determining a frequency boundary point of the overlapping region according to the parameter priority of the RF front-end; and
comparing a performance of the RF front-end at the RF working frequency point with that at the frequency boundary point, and selecting one of the two RF filters corresponding to the overlapping region to perform anti-interference filtering on the RF working frequency point according to a result of the comparison.

8. The method for segmenting RF front-end anti-interference filtering according to claim 7, wherein determining the frequency boundary point of the overlapping region according to the parameter priority of the RF front-end includes:
designing a sliding window, wherein a center frequency of the sliding window is a frequency point in the overlapping region, and a frequency width of the sliding window is an intermediate frequency signal bandwidth of the RF front-end; and
with signal amplitude as a priority, in the overlapping region, gradually sliding the sliding window from a minimum value of the frequency point to a maximum value of the frequency point, and taking the center frequency of the sliding window, where an absolute value of difference in amplitude flatness of the two RF filters within a frequency range of the sliding window reaches a minimum, as the frequency boundary point; or
with signal phase as a priority, in the overlapping region, gradually sliding the sliding window from a minimum value of the frequency point to a maximum value of the frequency point, and taking the center frequency of the sliding window, where an absolute value of difference in phase linearity of the two RF filters within a frequency range of the sliding window reaches a minimum, as the frequency boundary point; or
with signal delay as a priority, in the overlapping region, gradually sliding the sliding window from a minimum value of the frequency point to a maximum value of the frequency point, and taking the center frequency of the sliding window, where an absolute value of difference in group delay fluctuation of the two RF filters within a frequency range of the sliding window reaches a minimum, as the frequency boundary point; and
wherein in the two RF filters corresponding to the overlapping region, the center frequency of a previous RF filter is lower than the center frequency of a subsequent RF filter.

9. An electronic device, comprising:
one or more processors; and
a non-transitory storage device for storing one or more programs, wherein the one or more programs, when executed by the one or more processors, enable the electronic device to implement a method for segmenting RF front-end anti-interference filtering, wherein the method includes:
obtaining a RF working band to-be-covered of a RF front-end, and determining working bandwidth, number, and center frequency of required RF filters according to the RF working band based on a principle of minimizing the number of RF filters or maximizing an anti-interference capability, so that the working bandwidth of a switch-filter circuit formed by all RF filters at least covers each channel of the RF front-end; and
when there is an overlapping region in the working bandwidths of two RF filters with adjacent bandwidths in the switch-filter circuit; for an RF working frequency point in the overlapping region, selecting one of the two RF filters to perform anti-interference filtering on the RF working frequency point according to a parameter priority of the RF front-end.

10. An RF front-end module, comprising a switch-filter circuit manufactured under a guidance of a method for segmenting RF front-end anti-interference filtering, wherein the method includes:
obtaining a RF working band to-be-covered of a RF front-end, and determining working bandwidth, number, and center frequency of required RF filters according to the RF working band based on a principle of minimizing the number of RF filters or maximizing an anti-interference capability, so that the working bandwidth of a switch-filter circuit formed by all RF filters at least covers each channel of the RF front-end; and
when there is an overlapping region in the working bandwidths of two RF filters with adjacent bandwidths in the switch-filter circuit; for an RF working frequency point in the overlapping region, selecting one of the two RF filters to perform anti-interference filtering on the RF working frequency point according to a parameter priority of the RF front-end.
